(19) United States
(12) Patent Application Publication
(10) Pub. No.: US 2018/0255442 A1
(43) Pub. Date: Sep. 6, 2018

(54) PORTABLE TERMINAL, GATEWAY DEVICE AND ELECTRONIC DEVICE

(71) Applicant: AMBIT MICROSYSTEMS (SHANGHAI) LTD., Shanghai (CN)

(72) Inventor: SHU-MIN YANG, New Taipei (TW)

(21) Appl. No.: 15/972,245

(22) Filed: May 7, 2018

Related U.S. Application Data
(62) Division of application No. 15/083,367, filed on Mar. 29, 2016.

(30) Foreign Application Priority Data
Dec. 31, 2015 (TW) 104144801

(51) Int. Cl. H04W 4/14; H04W 76/15; H04W 4/80; H04W 12/06

(52) U.S. Cl. CPC H04W 4/14; H04W 76/15; H04W 4/80; H04W 88/16; H04W 12/06

(57) ABSTRACT

An electronic device communicates with a gateway device and a portable terminal. The electronic device receives notice information from the gateway device by. A password corresponding to the notice information is inputted by the electronic device. A message is received from the portable terminal via the gateway device and is presented to users by the electronic device. The message is edited by the electronic device. The edited message is transmitted to the gateway device for further being forwarded by the gateway device.

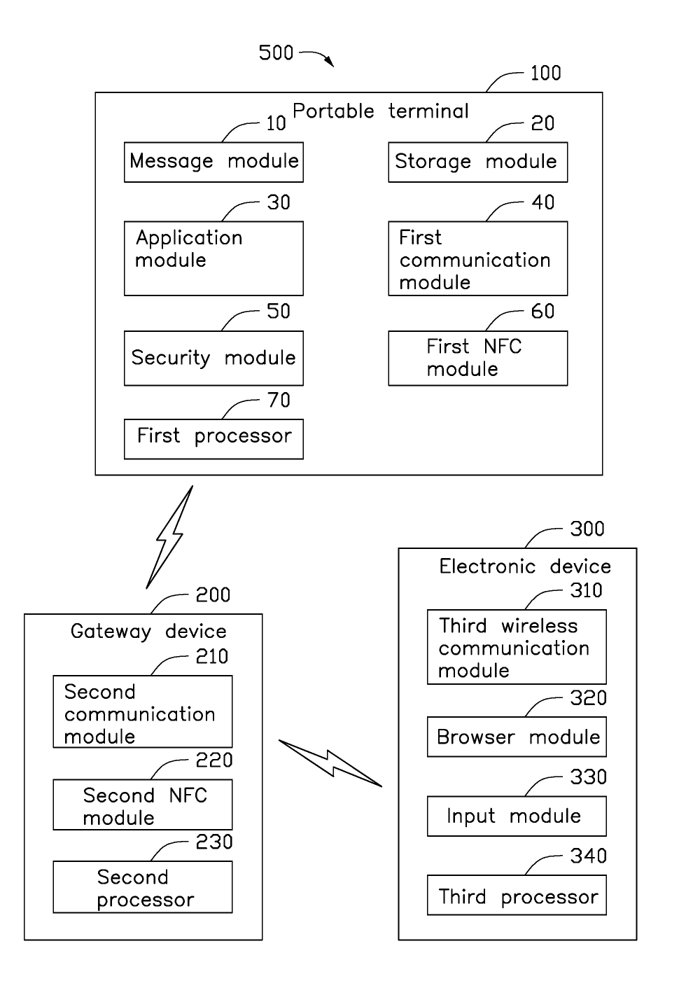

### CROSS-REFERENCE TO RELATED APPLICATIONS

The application is a divisional application of U.S. Ser. No. 15/083,367, filed Mar. 29, 2016.

### FIELD

The subject matter herein generally relates to a portable terminal, a gateway device, and an electronic device for effectively transmitting and receiving message.

### BACKGROUND

Portable terminals may be used for transmitting and receiving short messages. However, the limited size of the screen and keyboard of the portable terminals make them difficult to use to read and type by users with weak eyesight. Additionally, compared to inputting messages using portable terminals, inputting messages using a computer may be more convenience due to typing speed and habit.

### BRIEF DESCRIPTION OF THE DRAWINGS

Many aspects of the disclosure can be better understood with reference to the following figures. The components in the figures are not necessarily drawn to scale, the emphasis instead being placed upon clearly illustrating the principles of the disclosure. Moreover, in the drawings, like reference numerals designate corresponding parts throughout the several views. Implementations of the present technology will now be described, by way of example only, with reference to the attached figures, wherein:

The FIGURE is a block diagram of an exemplary embodiment of a message transmitting and receiving system.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “comprising,” when utilized, means “including, but not necessarily limited to”; it specifically indicates open-ended inclusion or membership in the so-described combination, group, series and the like.

The FIGURE illustrates an exemplary embodiment of a message transmitting and receiving system 500. The message transmitting and receiving system 500 includes a portable terminal 100, a gateway device 200 and an electronic device 300, which are wirelessly connected to each other to exchange data and information. The portable terminal 100 may be a smart phone, a tablet computer, or a personal digital assist (PDA), etc. The electronic device 300 may be a laptop computer or a personal computer. In at least one embodiment, the electronic device 300 has a larger size screen than the portable terminal 100 and a typical full-size keyboard for conveniently reading and typing messages by users.

The portable terminal 100 includes a message module 10, a storage module 20, an application module 30, a first communication module 40, a storage module 50, a first NFC (near field communication) module 60 and a first processor 70. The message module 10 is for transmitting and receiving messages, such as short message service (SMS). In at least one embodiment, the portable terminal 100 may be used to send information, such as, characters, audios, videos, images, via the message module 10 to other portable terminals, such as contacts of the user. The storage module 20 is for storing data; at least including a phonebook. The phonebook includes a plurality of contact numbers (e.g., phone numbers, email addresses, communication service user-ids, etc), with which the portable terminal 100 may conveniently send and receive messages. The portable terminal 100 may communicates with other portable terminals via the contact numbers. The application module 30 is for managing applications for better human-computer interaction. The first communication module 40 is for establishing wireless communication with the gateway device 200 for exchanging data. The wireless communication may be Wi-Fi or Bluetooth. The security module 50 is for encrypting the wireless communication and generating corresponding passwords. The first processor 70 is for processing the transmission and receiving of the messages and managing the phonebook and security information. The portable terminal 100 may selectively establish wireless communication via the first wireless communication module 40 and the first NFC module 60. In at least one embodiment, the application module 30 may provide options for connecting with the first wireless communication module 40 or the first NFC module 60 to the user. The first processor 70 may transmit the phonebook of the storage module 20 and the message of the message module 10 to the gateway device 200 via the first wireless communication module 40 and the first NFC module 60. The first processor 70 may further forward massages from the gateway device 200 to other portable terminals.

The gateway device 200 includes a second communication module 210, a second NFC module 220 and a second processor 230. The second communication module 210 is for establishing wireless communication with the first communication module 40 and the electronic device 300 for exchanging data between the two. The second NFC module 220 is for establishing near field communication with the first NFC module 60 for exchanging data. The second processor 230 is for processing the phonebook received from the portable terminal 100 and transmit notice information to the electronic device 300, and further transmit and receive messages. The gateway device 200 may send and receive messages with the contact numbers of the phonebook. The gateway device 200 may receive messages from the portable terminal 100 via the second communication module 210 or the second NFC module 220 and forward the messages to the electronic device 300, and vice versa.

The electronic device 300 includes a third wireless communication module 310, a browser module 320, an input module 330 and a third processor 340. The third wireless communication module 310 is for establishing wireless communication with the second wireless communication module 320 for exchanging data. The browser module 320 is for presenting the received messages and the notice information for conveniently browsing by user. In addition, the browser module 320 is for accessing the internet. In at least one embodiment, the notice information can be presented by displaying a conversation page. The input module 330 is for inputting the passwords and editing messages. The third processor 340 is for processing the transmission and receiving of the messages and the notice information.

In one embodiment, the portable terminal 100 establishes wireless communication with the gateway device 200 via the first communication module 40 and the second communication module 210, the gateway device 200 establishes wireless communication with the electronic device 300 via the second communication module 210 and the third wireless communication module 310. Therefore, the portable terminal 100, the gateway device 200 and the electronic device 300 are interconnected. The application module 30 inquires of the user about whether to transmit the phonebook of the storage module 20 to the gateway device 200 via a user interface. The user may operate and select via the application module 30. When transmitting the phonebook is selected, the first processor 70 triggers the first communication module 40 to transmit the phonebook to the gateway device 200. The security module 50 generates a temporary password during the transmission of the phonebook to encrypt the transmission, thereby protecting privacy and preventing the phonebook from being stolen. The temporary password is simultaneously presented on the user interface of the portable terminal 100 that can be conveniently read by user. The gateway device 200 generates notice information via the second processor 230 when the phonebook is received and transmits the notice information to the electronic device 300 via the second communication module 210. The browser module 320 displays a conversation page requiring the password when the electronic device 300 receives the notice information. The user may input the password via the input module 340 to activate the electronic device 300 to receive, transmit and edit the phonebook of the gateway device 200. When the message module receives a message sent by one of the contact numbers of the phonebook, the first processor 70 triggers the first communication module 40 to transmit the message to the gateway device 200. The second processor 230 forwards the message to the electronic device 300 via the second communication module 210. The user may read the message via the browser module 320 and then input response contexts for the message via the input module 330. The third processor 340 transmits the edited message to the gateway device 200 via the third wireless communication module 310. The second processor 230 directly responses the edited message to the other portable terminal via the contact number of the phonebook.

In other embodiments, the second processor 230 may further forward the edited message to the portable terminal 100 via the second communication module 210. The first processor 70 responses the edited message to the other portable terminal via the message module 10.

In other embodiments, the electronic device 300 displays the conversation page requiring the password. When an incorrect password is inputted or the conversation page is closed by the user, the user may continuously access the internet with the browser module 320. When the password is correctly inputted in the conversation page, the electronic device automatically receives the messages and presents the messages via the browser module 320.

In other embodiments, the application module 30 may further provide an automatic reading mode and a notice mode for being selected. When the automatically reading mode is selected, the portable terminal 100, the gateway device 200 and the electronic device 300 establish encrypted wireless communication in above-described method, the message can be automatically forwarded to the electronic device 300 every time the message module 10 receives a message. When the notice mode is selected, the application module 30 displays a notice item to ask the user whether the user wants to read the message via the electronic device 300. When a positive answer is selected by the user, the message is forwarded to the electronic device 300; when a negative answer is selected by the user, the message is read on the portable terminal 100 only.

In another embodiment, the portable terminal 100 establishes near field communication with the gateway device 200 via the first NFC module 60 and the second NFC module 220, the gateway device 200 establishes wireless communication with the electronic device 300 via the second communication module 210 and the third wireless communication module 310. Thus the portable terminal 100 and the gateway device 200 transmit and receive the massage via the first NFC module 60 and the second NFC module 220 when within a predetermined near field communication range. In this embodiment, transmitting the message with near field communication be more convenient and may simplify user's operation on the portable terminal 100.

The portable terminal 100 transmits messages to the electronic device 300 via the gateway device 200. The messages can be read and edited on a larger size screen and a more convenient full size input keyboard of the electronic device 300. This may be convenient for users, especially for the users with weak eyesight and who are not used to type on small size keyboards.

The embodiments shown and described above are only examples. Many details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail. It is believed that the embodiments and their advantages will be understood from the foregoing description, and it will be apparent that various changes may be made thereto without departing from the scope of the disclosure or sacrificing all of its advantages, the examples hereinbefore described merely being illustrative embodiments of the disclosure.

What is claimed is:

1. An electronic device communicating with a gateway device and a portable terminal, the electronic device comprising:
at least one processor;
a non-transitory storage medium system coupled to at least the one processor and configured to store one or more programs that are to be executed by the at least one processor, the one or more programs comprises instructions for:
receiving notice information from the gateway device;
inputting a password corresponding to the notice information;
receiving a message from the portable terminal via the gateway device;
presenting the message to users;
editing the message; and
transmitting the edited message to the gateway device for further being forwarded by the gateway device.

2. The electronic device as claimed in claim 1, wherein the one or more programs further comprises instructions for:
establishing wireless communication with the gateway device; and
receiving the message and the notice information from the gateway device via the wireless communication.

3. The electronic device as claimed in claim 1, wherein the notice information is a conversation page displayed on the electronic device for inquiring whether to receive the messages and input the password.

4. The electronic device as claimed in claim 3, wherein the one or more programs further comprises instructions for:
accessing the internet; and
accessing, continuously, the internet when an incorrect password is inputted or the conversation page is closed by the user.

5. The electronic device as claimed in claim 4, wherein the one or more programs further comprises instructions for:
receiving the messages and presenting the messages on the electronic device when the password is inputted in the conversation page.
